(19) United States
(12) Patent Application Publication
(10) Pub. No.: US 2007/0171203 A1
(43) Pub. Date: Jul. 26, 2007

(54) Method for functioning a mouse Zx scroll with a standard mouse driver

(76) Inventors: Yen-Chang Chiu, Linkou Shiang (TW); Yung-Lieh Chien, Taoyuan City (TW); Tso-Chieh Yang, Chingshuei Townsh (TW); Cheng-Hao Tang, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/268,537

(22) Filed: Nov. 8, 2005

(30) Foreign Application Priority Data
Nov. 10, 2004 (TW) 093134339

(51) Int. Cl. G09G 5/08

(52) U.S. Cl. 345/163

(57) ABSTRACT

In a method for functioning a mouse Zx scroll with a standard mouse driver, a pair of middle-button signals of a mouse are generated by a standard mouse driver of Microsoft to sandwich a horizontal movement amount signal when scrolling a horizontal scroll bar of a window by a Zx mechanism of the mouse. Since the horizontal scroll bar is operated only by the standard mouse driver of Microsoft, there is no need of additional or specific mouse driver for the Zx function of a mouse.

### FIELD OF THE INVENTION

The present invention is generally related to a mouse Zx scroll control and, more particularly, to a method for functioning a mouse Zx scroll with a standard mouse driver.

### BACKGROUND OF THE INVENTION

Computer mouse is a fundamental equipment of a computer system. The way of a conventional mouse to scroll a window is using the pointing icon of the mouse to operate the scroll bars of the window. As shown in FIG. 1, when the pointing icon of a mouse is pointed on the vertical scroll bar 10 or the horizontal scroll bar 20 together with the left button of the mouse pressed during a drag of the mouse, the window is scrolled vertically or horizontally. Alternatively, the window is able to be scrolled vertically or horizontally by continuously clicking the left button of the mouse when the pointing icon of the mouse is pointed on the vertical scrolling area 12 or the horizontal scrolling area 22. However, such operations require precisely pointing the pointing icon of the mouse on the specific regions on the window and continuously move the mouse during the scroll control period, and additionally, the user's hand needs large movement, thereby causing the user's operations inconvenient. It was therefore proposed Z-axis mechanism, such as mechanical or optical wheel, additionally combined on a mouse for the scroll control of a window to improve the operations more convenient. In a conventional mouse, the Z-axis is a Zy-axis, to provide the vertical scroll control of a window. While in state-of-art, a standard three-dimensional mouse provides two-dimensional Z-axis functions, i.e., Zx and Zy, by dual wheels for example, for vertical and horizontal scroll controls of a window, respectively, thereby simplifying the corresponding operations. However, such mouse requires specific driver added to the computer system for functioning the Zx control. This specific driver has to be compatible with the hardware of the mouse and preinstalled to the computer system. In some circumstances, for example when a mouse is replaced with another one or the driver is lost, the horizontal scroll control of a window will not be functioning by the Zx mechanism of the mouse any more.

On the other hand, for the Zy function of a mouse, Microsoft had its Windows system equipped with a middle-button function in the standard mouse driver, and predefines that function in such manner that the first pressing of the middle button will use the vertical movement of the mouse as the vertical scroll of the vertical scroll bar, and the second pressing of the middle button will turn the mouse back to its original state. This is the special function provided for a three-button mouse and is the only method in the current standard mouse driver to scroll the scroll bar of a window. As shown in FIG. 1, once the middle button of a mouse is pressed, a Zy icon 30 is shown on the window. As long as this Zy icon 30 stays on the window, the vertical movement of the mouse is treated as the scrolling of the vertical scroll bar 10. To stop functioning the vertical scrolling of the window, the middle button of the mouse is pressed again, and the Zy icon 30 disappears. Then it returns back to the original operational mode. The standard mouse driver of Microsoft exists in the computer system once a Windows system is installed, and users need not to install any other programs or to perform any setup for a standard mouse function. It is so convenient accordingly. The problem is that, this standard mouse driver provides only the Zy function, and no Zx function is available.

Therefore, it is desired a method for functioning a mouse Zx scroll with a standard mouse driver, but not requiring additional mouse driver.

### SUMMARY OF THE INVENTION

An object of the present invention is to provide a method for functioning a mouse Zx scroll, which uses a standard mouse driver, but not requires additional mouse driver, for the horizontal scroll control of a window.

In a method for functioning a mouse Zx scroll with a standard mouse driver, according to the present invention, a first middle-button signal of a mouse is generated by the standard mouse driver in response to a trigger signal generated by a mechanism of the mouse, a horizontal movement amount signal follows, and a second middle-button signal of the mouse is generated again by the standard mouse driver.

Due to the first and second middle-button signals generated by the standard mouse driver to sandwich the horizontal movement amount signal for functioning a scroll control of a horizontal scroll bar leftward or rightward, there is no need of additional or specific mouse driver.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows conventional scroll bar operations of a window;

FIG. 2 shows a signal frame of a mouse when using a standard mouse driver of Microsoft;

FIG. 3 shows a signal frame of a mouse when using a conventional mouse driver having Zx function;

FIG. 4 shows a flowchart in one embodiment of the present invention for functioning a mouse Zx scroll with a standard mouse driver;

FIG. 5 shows an equivalent process in an operation according to the flowchart shown in FIG. 4;

FIG. 6 shows a signal frame combination during an operation shown in FIG. 5; and

FIG. 7 shows a mouse having two-dimensional Z-axis function.

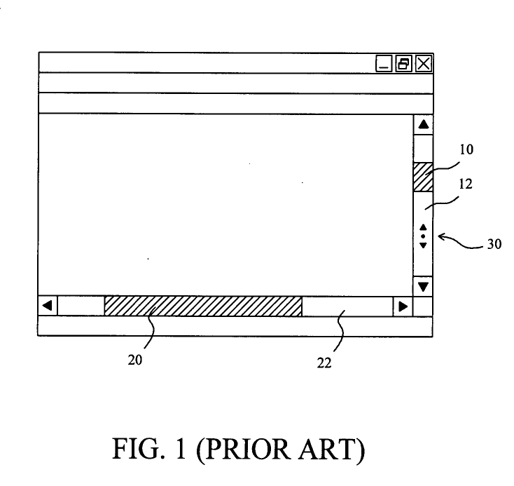

### DETAILED DESCRIPTION OF THE INVENTION

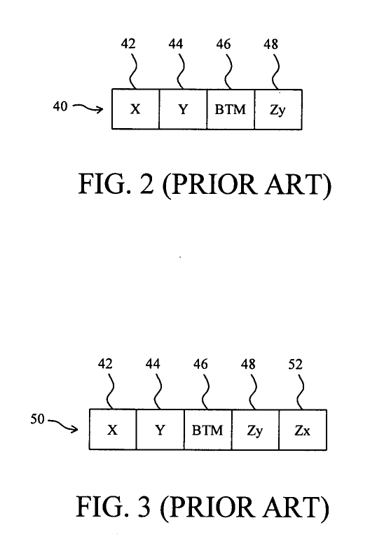

To illustrate the principles of the present invention, two signal frames in mouse signals when using conventional mice are described first by FIGS. 2 and 3. FIG. 2 shows a signal frame 40 of a mouse when using a standard mouse driver of Microsoft. Each time a standard mouse driver of Microsoft sends out a mouse signal 40, it includes fields 42 and 44 for the X and Y coordinates of the mouse, field 46 for the middle-button information, and field 48 for the vertical movement amount of the mouse. The field 46 has 3 bits of data, while the other three 42, 44 and 48 have 8 bits of data. FIG. 3 shows a signal frame 50 of a mouse when using a conventional mouse driver having Zx function, in which, in addition to the fields 42 to 48 as that of a standard mouse signal, it further includes field 52 for the horizontal movement amount to control the movement of the horizontal scroll bar. Since the signal format of the frame 50 is different from that of the standard one 40, additional driver is required to be installed in the computer system in advance.

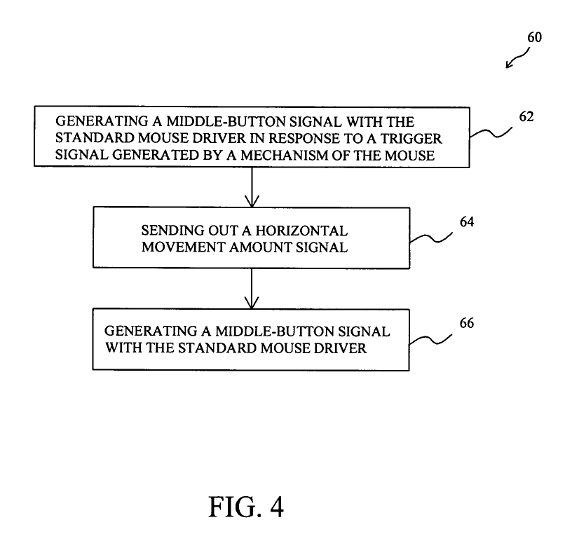

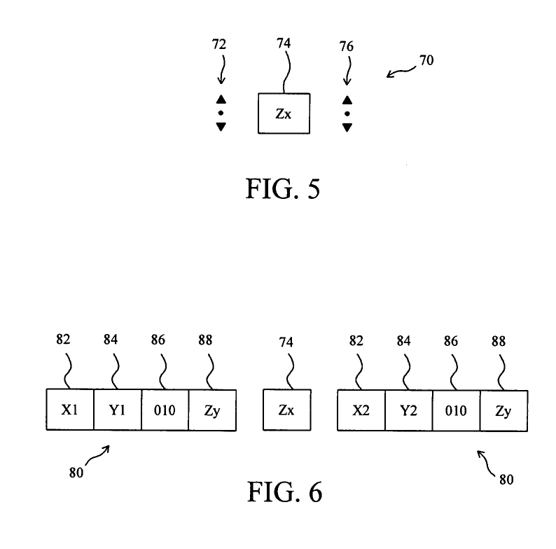

FIG. 4 shows a flowchart 60 in one embodiment of the present invention for functioning a mouse Zx scroll with a standard mouse driver. In step 62, a middle-button signal of a mouse is generated by the standard mouse driver in response to a trigger signal generated by a mechanism of the mouse. In the Z-axis control of a typical mouse, when the user operates a Z-axis of the mouse, a trigger signal is issued in response to the operation the Z-axis at first. However, in this flowchart 60, a middle-button signal will be automatically generated in response to the trigger signal generated by the Zx mechanism of the mouse as that generated by the standard mouse driver. The horizontal movement amount is then sent out in step 64, followed by step 66, a middle-button signal automatically generated again as that generated by the standard driver. FIG. 5 shows an equivalent process in an operation according to the flowchart 60, which comprises a middle-button signal 72, field 74 for the horizontal movement amount, and another middle-button signal 76. This operation signal 70 has the frame combination shown in FIG. 6. In detail, a mouse signal 80 is first generated with the field 86 for the middle-button having the value ‘010’ to indicate a pressed mouse middle button, then the field 74 for the horizontal movement amount follows, and another mouse signal 80 indicating a pressed mouse middle button terminates this Zx operation. The two mouse signals 80 sandwiching the field 74 for the horizontal movement amount are added automatically. The user actually does not press the mouse middle button during such operation. In the mouse signal 80, the other fields 82 for the X coordinate, 84 for the Y coordinate, and 88 for the vertical movement amount, are not used in this Zx scrolling. FIGS. 5 and 6 are exemplary diagrams. The field 74 for the horizontal movement amount may be implemented with standard format or others. The Zx scrolling shown above may be accomplished by process control.

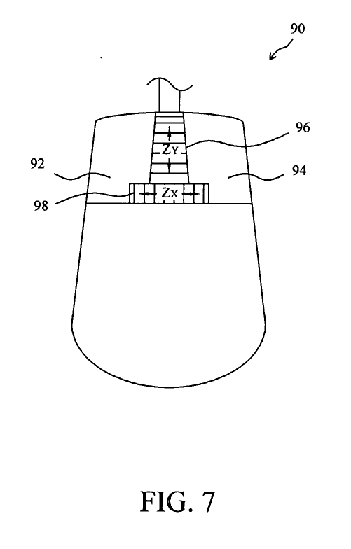

FIG. 7 shows a mouse 90 having two-dimensional Z-axis function, whose left button 92 and right button 94 function as a typical mouse, while Zy-axis 96 and Zx-axis 98 implemented with touchpad both realize the vertical and horizontal scroll control of a window by using the standard mouse driver of Microsoft. When scrolling the horizontal scroll bar of a window, as in the operation on a conventional Zx-axis, the scroll amount resulted from the movement of the user's finger on the Zx-axis 98 is used to scroll the horizontal scroll bar of the window. However, the touch of the user's finger on the Zx-axis 98 hereof will induce the automatic generation of two mouse middle-button signals to sandwich the horizontal movement amount, among which, the first mouse middle-button signal is used as the start-up signal of the horizontal scrolling, and the second is used as the termination signal of the horizontal scrolling. Therefore, no additional mouse driver is needed for functioning the scrolling of the horizontal scroll bar. In addition to the Zx-axis 98 implemented with touchpad shown in FIG. 7, it may be implemented with other mechanisms, such as wheel, button and any others, to trigger the flowchart 60.

By using the middle-button function of the Microsoft standard mouse driver for the start-up and termination signals of scrolling the horizontal scroll bar of a window, with the Zx movement amount therebetween, it accomplishes the horizontal scroll control of the window without any other mouse drivers.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as string forth in the appended claims.

What is claimed is:

1. A method for functioning a mouse Zx scroll with a standard mouse driver, comprising the steps of:
generating a first middle-button signal of a mouse by the standard mouse driver in response to a trigger signal generated by a mechanism of the mouse;
sending out a horizontal movement amount signal; and
generating a second middle-button signal of the mouse by the standard mouse driver.

2. The method of claim 1, wherein the mechanism comprises a button.

3. The method of claim 1, wherein the mechanism comprises a touchpad.

4. The method of claim 1, wherein the mechanism comprises a wheel.
